(19) United States
(12) Patent Application Publication
(10) Pub. No.: US 2005/0198670 A1
(43) Pub. Date: Sep. 8, 2005

(54) Broadcast receiver having viewing reservation function

(75) Inventor: Yukio Nishimoto, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD.,, Takefu-city (JP)

(21) Appl. No.: 11/068,755

(22) Filed: Mar. 2, 2005

(30) Foreign Application Priority Data
Mar. 5, 2004 (JP) 2004-061838

(51) Int. Cl. H04N 7/173; G06F 13/00; H04N 5/445; G06F 3/00

(52) U.S. Cl. 725/58; 725/86; 725/87

(57) ABSTRACT

The present invention provides a broadcast receiver having viewing reservation function which, when a viewer is viewing a different program while a program is reserved for viewing, allows the viewer not only to select and switch a program reserved for viewing according to the viewer's judgment but also to select whether the program reserved for viewing or the program that the viewer is currently viewing should be recorded, or to cancel the viewing reservation. Viewing reservation information of a program reserved for viewing is stored in a viewing reservation data storing unit 21 of a main microcomputer 4. If a broadcast starting time reserved for viewing approaches in a state in which the viewer is viewing a program sent from a tuner, a message display unit 24 displays a channel change confirmation message and a recording confirmation message, and the viewer can selectively switch the program that the viewer is currently viewing or the program reserved for viewing according to the viewer's judgment. At the same time, the viewer can select whether the program reserved for viewing or the program that the viewer is currently viewing should be recorded or the recording reservation should be cancelled.

The present application is based on and claims priority of Japanese patent applications No. 2004-061838 filed on Mar. 5, 2004, the entire contents of which are hereby incorporated by reference.

### BACKGROUND OF THE INVENTION

1. Field of the Invention

The present invention relates to a broadcast receiver having a viewing reservation function, and in particular, to a broadcast receiver having a viewing reservation function which, when a viewer is viewing a different program while a program is reserved for viewing, allows the viewer to select and switch to the program reserved for viewing according to the viewer's judgment and also allows the viewer to select whether the viewer should record the program reserved for viewing or the program that the viewer is viewing, or should cancel the viewing reservation.

2. Description of the Related Art

Conventionally, with a broadcast receiver such as a television receiver, when a viewer makes a viewing reservation of a program, the viewer operates a remote controller or the like to input a channel of a broadcasting station, a program starting time, and a program ending time of the program that the viewer wishes to record. In addition, as an auxiliary means for a viewing reservation, an Electronic Program Guide (EPG) has been well-known. The EPG includes information such as a broadcasting station names, a program name, program starting times, and program ending times. For example, with the EPG, a program table of a designated date and time is displayed on a screen, and a viewer can operate this program table to inspect detailed information of a specific program or make the viewing reservation described above. When the viewing reservation is made, when a selected program is started, the receiver performs processing such as automatic tuning to record or store the selected program in a storage device built in the receiver or externally connected to the receiver such as an analog video recorder, a digital video recorder, or a hard disk. In case in which a viewing reservation is set or viewing reservations are redundantly set in the same time frame, when it comes to a starting time of a viewing reservation program in the middle of a program of a channel that the viewer is currently viewing, in general, the viewer switches to the channel of a program reserved for viewing. Consequently, the viewer cannot continue to view the program of the channel that the viewer is currently viewing.

As a technique for solving such a problem, Japanese Patent Laid-Open Publication No. 11-266414 (Patent Document 1) discloses an EPG receiver that is structured to allow a viewer to judge whether the viewer should switch a channel by using a reminding function to display information for informing the viewer that a broadcast reserved for viewing is about to start immediately before the start of the broadcast reserved for viewing. Further, Japanese Patent Laid-Open Publication No. 2001-197382 (Patent Document 2) discloses a program receiver with viewing program selecting means for selecting a program reserved for viewing on the basis of priority setting conditions decided in advance with viewing reservations that are redundantly set in the same time frame.

In the technique disclosed in Patent Document 1, when a viewer is viewing a different program while a program is reserved for viewing, the EPG receiver allows the viewer to confirm that a starting time of a broadcast reserved for viewing is approaching immediately before the start of the program reserved for viewing and select whether the viewer should switch the program to the program reserved for viewing according to the viewer's judgment. In the technique disclosed in Patent Document 2, when viewing reservations are made redundantly in the same time frame, the program receiver allows a viewer to select a program to be received on the basis of priority setting conditions decided in advance. However, both of the techniques do not provide display means for confirming which of a program that a viewer is currently viewing or a program reserved for viewing should be recorded. Consequently, it is likely that the viewer misses the program that the viewer is currently viewing or the program reserved for viewing immediately before the start of the broadcast of the program reserved for viewing. Moreover, it is also likely that the start of the recording may delay.

### SUMMARY OF THE INVENTION

The invention has been devised in view of the problems described above, and it aims at providing a broadcast receiver having a viewing reservation function that, when a viewer is viewing a different program while a program is reserved for viewing, allows the viewer not only to select and switch a program reserved for viewing, but also to select whether the program reserved for viewing or the program that the viewer is currently viewing should be recorded, or the viewing reservation should be cancelled according to the viewer's judgment.

A broadcast receiver having a viewing reservation function according to the first aspect of the invention comprises a viewing reservation data storing unit that stores a channel of a program to be reserved for viewing and a broadcast time frame of the program as viewing reservation data, a message display unit that displays a channel change confirmation message indicating whether a channel should be changed from a program that a viewer is currently viewing to the program reserved for viewing and a recording confirmation message indicating whether the program that the viewer is currently viewing or the program reserved for viewing should be recorded immediately before the start of the program reserved for viewing based on the viewing reservation data of the viewing reservation data storing unit, a channel tuning unit that performs tuning in accordance with an instruction of the channel change confirmation message, and a recording operation unit that obtains time information from the viewing reservation data stored in the viewing reservation data storing unit and records a program according to an instruction of the recording confirmation message at the start of a reservation time.

According to this arrangement, a channel change confirmation message which urges a viewer to confirm channel change immediately before the start of a program reserved for viewing is displayed, and if the viewer selects to change a channel according to the viewer's judgment, a channel is switched from a program that the viewer is currently viewing to the program reserved for viewing, and on the other hand, if the viewer selects not to change a channel, the program that the viewer is currently viewing is displayed continuously. Thereafter, a recording confirmation message which indicates whether the program that the viewer is currently viewing or the program reserved for viewing should be recorded is displayed. If the viewer selects to record one of the programs according to the viewer's judgment, the program that the viewer is currently viewing or the program reserved for viewing is recorded, and if the viewer selects not to record any program, the viewing reservation is cancelled.

A broadcast receiver having a viewing reservation function according to the second aspect of the invention further comprises, in the broadcast receiver having a viewing reservation function according to the first aspect of the invention, a selecting means that selects whether the channel change confirmation message or/and the recording confirmation message should be displayed.

According to this arrangement, the viewer selects whether the channel change confirmation message or/and the recording confirmation message should be displayed, whereby a viewing reservation is made according to a reservation method selected by the viewer.

A broadcast receiver with a viewing reservation function according to the third aspect of the invention further comprises, in the broadcast receiver with a viewing reservation function according to the first or the second aspect of the invention, a selecting means that selects a time setting for display timing of the channel change confirmation message or/and the recording confirmation message that are displayed before the viewing reservation time.

According to this arrangement, the channel change confirmation message is displayed at the display timing set by the viewer when a broadcast starting time at which a program is reserved for viewing approaches, and then, the recording confirmation message is displayed.

According to the broadcast receiver having a viewing reservation function according to the first aspect of the invention, the broadcast receiver includes the viewing reservation data storing unit that stores a channel of a program to be reserved for viewing and a broadcast time frame of the program as viewing reservation data, the message display unit that displays a channel change confirmation message indicating whether a channel should be changed from a program that a viewer is currently viewing to the program reserved for viewing, and a recording confirmation message indicating whether the program that the viewer is currently viewing or the program reserved for viewing should be recorded immediately before the start of the program reserved for viewing based on the viewing reservation data of the viewing reservation data storing unit, the channel tuning unit that performs tuning in accordance with an instruction of the channel change confirmation message, and the recording operation unit that obtains time information from the viewing reservation data stored in the viewing reservation data storing unit and records a program according to an instruction of the recording confirmation message at the start of a reservation time. Thus, when the viewer is viewing a different program while a program is reserved for viewing, the viewer can select and switch to the program reserved for viewing according to viewer's judgment and can also select whether the program reserved for viewing or the program that the viewer is currently viewing should be recorded, or the viewing reservation should be cancelled. Consequently, it is hardly likely that the viewer misses the program that the viewer is currently viewing or the program reserved for viewing, and the start of the recording may delay. Thus, the viewer can record a program that the viewer desires.

According to the broadcast receiver having a viewing reservation function according to the second aspect of the invention, the broadcast receiver further comprises, in the broadcast receiver having a viewing reservation function according to the first aspect of the invention, the selecting means that selects whether the channel change confirmation message or/and the recording confirmation message should be displayed. Thus, it is possible to set a recording operation method that is convenient for the viewer.

According to the broadcast receiver having a viewing reservation function according to the third aspect of the invention, the broadcast receiver further comprises, in the broadcast receiver having a viewing reservation function according to the first or the second aspect of the invention, the selecting means that selects a time setting for display timing of the channel change confirmation message or/and the recording confirmation message that are displayed before the viewing reservation time. Thus, it is possible to display the channel change confirmation message and the recording confirmation message at optimum timing for the viewer.

### BRIEF DESCRIPTION OF THE DRAWINGS

FIG. 1 is a block diagram showing a circuit structure of a program receiver of the invention;

FIG. 2 is a block diagram showing a circuit structure in a main microcomputer in the present invention;

FIG. 3 is an explanatory diagram showing a setting screen at the time when a viewing reservation is made in the invention;

FIG. 4 is a flowchart showing operations until a program reserved for viewing is recorded in the invention; and

FIG. 5 is a flowchart showing operations until a program is recorded for each program in the invention.

### DETAILED DESCRIPTION OF THE PREFERRED EMBODIMENTS

Now, a preferred embodiment of the present invention will be hereinafter described with reference to the accompanied drawings.

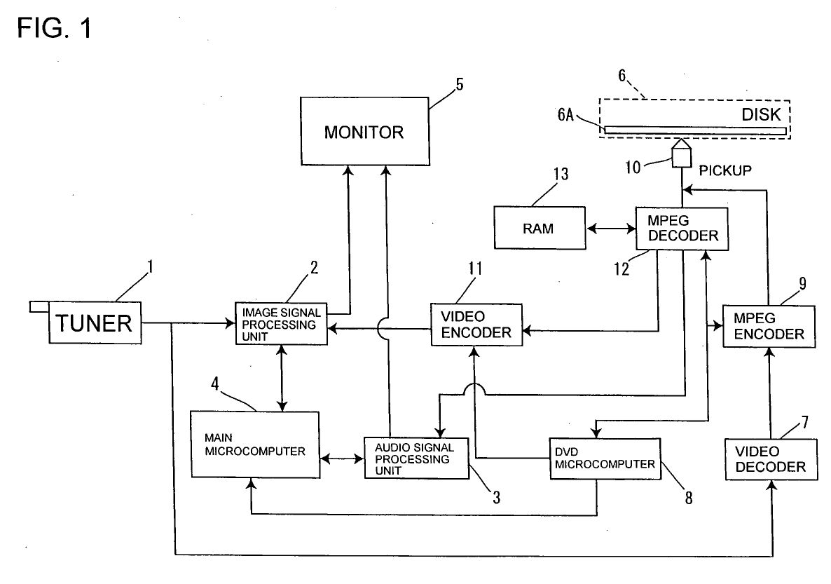

FIG. 1 is a block diagram showing a circuit structure of a program receiver which is an embodiment of the present invention. In FIG. 1, reference number 1 denotes a tuner, 2 denotes a video signal processing unit, 3 denotes an audio signal processing unit, and 4 denotes a main microcomputer. Video and audio signals sent from the tuner 1 are outputted to the video signal processing unit 2. The video signal processing unit 2 extracts the video signal sent from the tuner 1 and outputs the video signal to the main microcomputer 4 to cause the main microcomputer 4 to perform processing for projecting videos on a monitor 5 such as a CRT. In addition, the main microcomputer 4 outputs the audio signal, which is sent from the video signal processing unit 2, to the audio signal processing unit 3. The audio signal processing unit 3 performs processing for generating sounds from the monitor 5.

When, for example, a digital versatile disk (DVD) 6 is connected to the program receiver as a storage and reproduction apparatus to perform storage/reproduction for a disk 6A, video and audio signals from the tuner 2 are inputted to a video decoder 7. The video decoder 7 converts an analog signal into a digital signal and outputs the digital signal to a DVD microcomputer 8 and an MPEG encoder 9. The MPEG encoder 9 compresses the digital signal and outputs the compressed digital signal to the pickup 10. The DVD microcomputer 8 outputs the digital signal to a video encoder 11 and an MPEG decoder 12, wherein the video encoder 11 converts the digital signal to an analog signal and the MPEG decoder 12 performs processing for decompressing the compressed digital signal. And then, the video encoder 11 and the MPEG decoder 12 output the analog signal and the digital signal to the video signal processing unit 2 and the audio signal processing unit 3, where a processing for generating videos and sounds from the monitor 5 is performed. Note that in FIG. 1, reference number 13 denotes a memory (RAM) that stores information from the MPEG decoder 12.

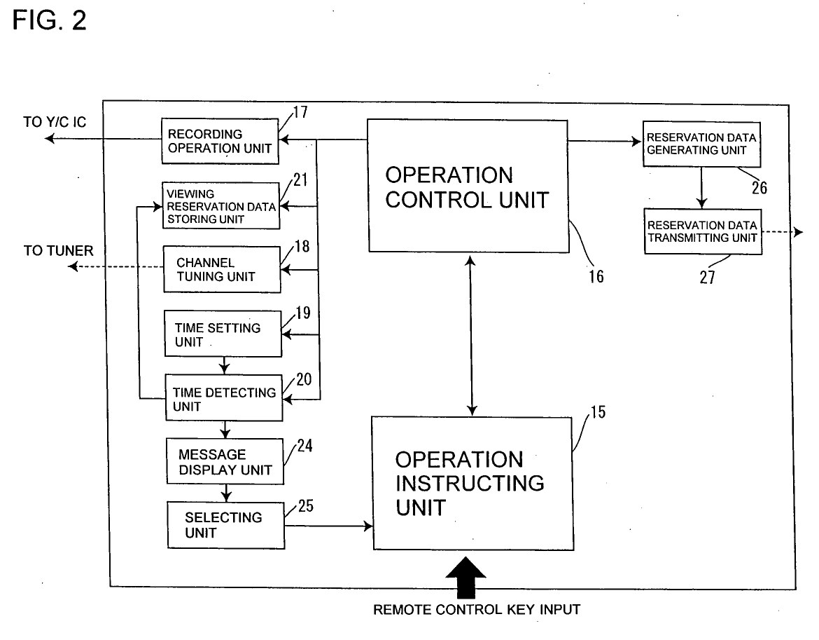

FIG. 2 is a block diagram showing a circuit structure in the main microcomputer 4 that performs processing for reserving a program for viewing on the basis of various instruction signals sent from a remote controller or a main body of the program receiver. In FIG. 2, reference number 15 denotes an operation instructing unit that receives various instruction signals and instructs respective units in the microcomputer 4 to perform processing, and reference number 16 denotes an operation control unit that controls the respective units in the microcomputer 4 in accordance with the instructions from the operation instructing unit 15. On the basis of the instructions from the operation instructing unit 15, the operation control unit 16 outputs the instruction signals to a recording operation unit 17 that outputs a recording operation signal to a Y/C IC, a channel tuning unit 18 that outputs a channel switching signal to the tuner 1, a time setting unit 19 that causes a message display unit 24 to display an indication that a broadcast of a program reserved for viewing is about to start immediately before the start of the program reserved for viewing, a time detecting unit 20 that detects a present time, and a viewing reservation data storing unit 21 that stores a channel and a time frame of a program to be reserved for viewing set by a viewer as viewing reservation information data. By outputting the instruction signals to these units, the operation control unit 16 performs viewing reservation processing. The message display unit 24 displays a channel change confirmation message and a recording confirmation message for the viewer immediately before the program reserved for viewing is started. A selecting unit 25 judges whether the viewer has selected one of the channels in response to the channel change confirmation message and the recording confirmation message displayed on the message display unit 24. Channel information judged in the selecting unit 25 is outputted to a reservation data generating unit 26 via the operation instructing unit 15 and the operation control unit 16, wherein the reservation data generating unit 26 generates reservation data such as an EPG and a G code such that the recording can be started at a reservation starting time in a channel instructed by the selecting unit 25, and a reservation data transmitting unit 27 outputs the reservation data to a storage/reproduction device such as the DVD 6.

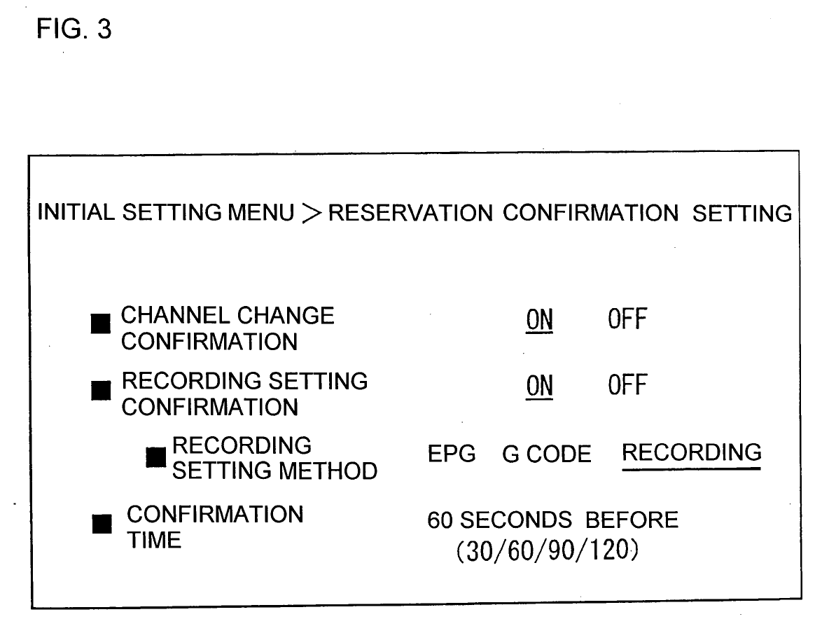

Further, a viewer can select a setting for conditions in making a viewing reservation. This selection will be explained with reference to an explanatory diagram of a setting screen in FIG. 3. When the viewer selects a menu key with a remote control transmitter or the like, an initial setting menu is displayed on a display screen. And by selecting a reservation confirmation setting, the viewer sets respective items of “channel change confirmation”, “recording setting confirmation”, “recording setting method”, and “confirmation time”. Here, the viewer operates an up-down key of the remote control transmitter to thereby move the selection items in the vertical direction in order and select a desired item. Then, by operating a determination key, the viewer can select whether the “channel change confirmation” and/or the “recording setting confirmation” is performed, and in which of methods “EPG”, “G code”, or “recording” the reservation setting is performed in the “recording setting method”, and set the “confirmation time” in displaying a message to timing of 30, 60, 90, or 120 seconds before the start of a broadcast of a program reserved for viewing. Note that the timing of this “confirmation time” can be set by the viewer to an arbitrary time other than the predetermined times of 30, 60, 90, and 120 seconds. FIG. 3 shows a state in which the “channel change confirmation”, the “recording setting confirmation”, and the “recording setting method” are selected to be displayed, respectively, and the timing for recording and displaying of a message is set to 60 seconds before the start of a broadcast of a program reserved for viewing as the “recording setting method”.

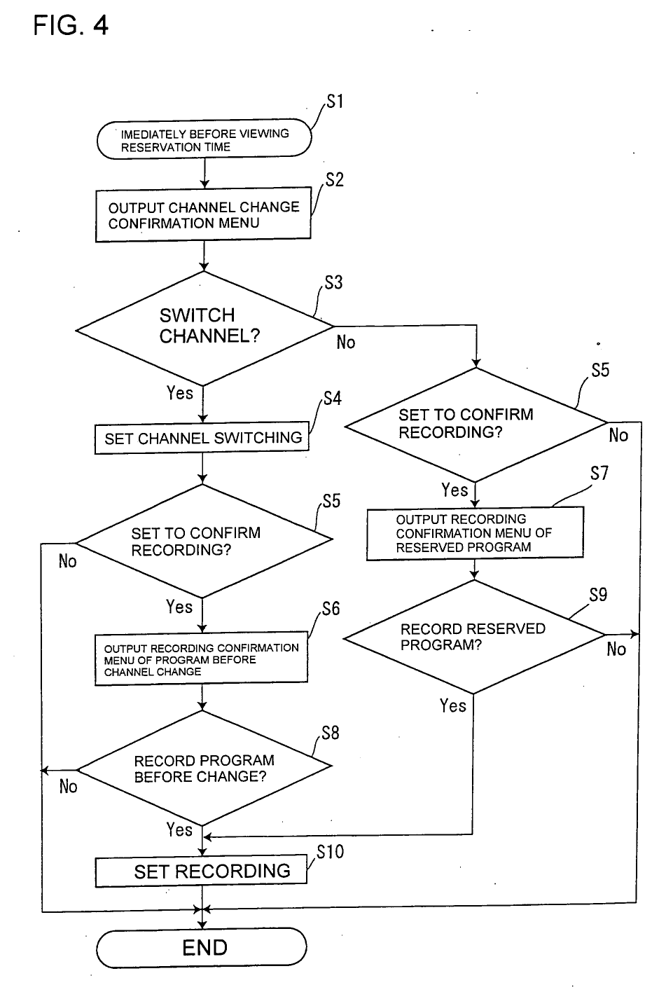

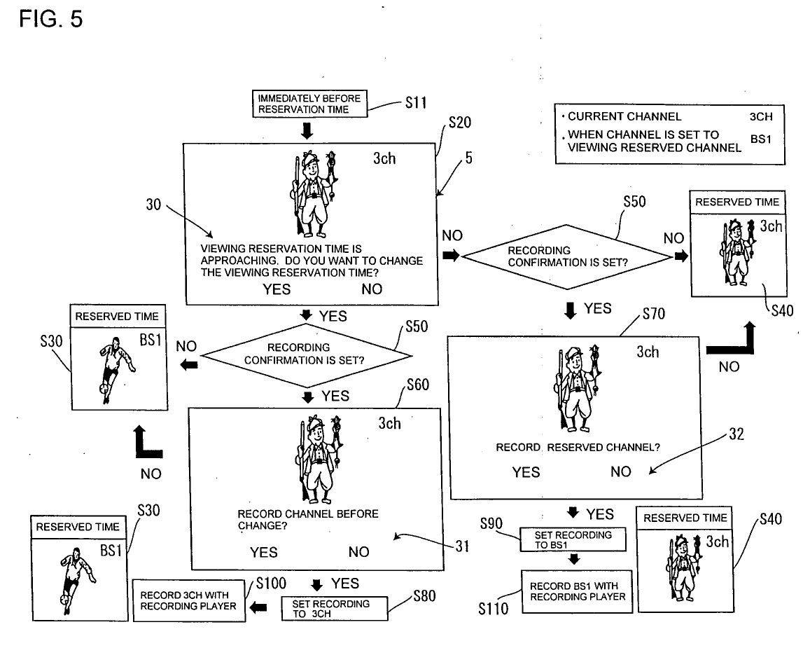

FIG. 4 is a flowchart showing operations until a program reserved for viewing is recorded, and FIG. 5 is a flowchart showing operations until each program is recorded. The operations until a program reserved for viewing is recorded will be explained with reference to these flowcharts. FIG. 5 shows a case in which a viewer views 3CH and sets a viewing reservation to BS1. Viewing reservation information of the program reserved for viewing is stored in the viewing reservation data storing unit 21 of the main microcomputer 4. In a state in which the viewer is viewing a program (3CH) sent from the tuner 1 and the “channel change confirmation” is selected to be displayed, the message display unit 24 outputs a signal to the monitor 5, wherein a channel change confirmation message 30 is displayed together with a video sent from the tuner 1 when a broadcast starting time of a program (BS1) reserved for viewing approaches (steps S1 and S11). The timing for displaying this channel change confirmation message 30 is the time set in the item “confirmation time”. When the timing is set to “60 seconds before” in FIG. 3, the channel change confirmation message 30 “Viewing time is approaching. Do you want to change the viewing time?” is displayed 60 seconds before the start of the broadcast (steps S2 and S20). Then the viewer selects whether a channel is switched from the program that the viewer is currently viewing to the program reserved for viewing in accordance with the instruction of the channel change confirmation message 30 (step S3). When the viewer selects “Yes” in the channel change confirmation message 30 with a key input of the remote control transmitter according the viewer's judgment, the channel is switched to the program reserved for viewing at a time reserved by the channel tuning unit 18 (steps S4 and S30). On the other hand, when the viewer selects “No” in the channel change confirmation message 30, the program that the viewer is currently viewing is displayed continuously even after the reserved time (step S40). Further, if it is judged whether or not the confirmation of a recording is selected in the item “recording setting confirmation” at the time of setting (steps S5 and S50), and if the setting is made to confirm the recording, the message display unit 24 displays a recording confirmation message on the monitor 5. However, when the viewer has changed the channel from the program that the viewer is currently viewing to the program reserved for viewing in steps S4 and S30, a recording confirmation message 31 “Do you want to record the channel before change?” is displayed on the monitor 5 (steps S6 and S60). On the other hand, when the program that the viewer is currently viewing is displayed continuously, a recording confirmation message 32 “Do you want to record the reserved channel?” is displayed (steps S7 and S70). Then, the viewer selects whether the program should be recorded or not with a key input of the remote control transmitter according to the viewer's judgment in accordance with instructions of the recording confirmation messages 31 and 32 (steps S8 and S9). In other words, when the viewer selects “Yes” in the recording confirmation message 31 in step S8, recording is set for the channel before switching (3CH), and when the viewer selects “Yes” in the recording confirmation message 32 in step S9, recording is set for the reserved channel (BS1) (steps S10, S80, and S90). This setting for recording is outputted to the reservation data generating unit 26, and recording of the designated program is started at the reserved starting time (steps S100 and S110). In addition, when “No” is selected in steps S8 and S9, processing for canceling the recording reservation is performed.

As described above, in this embodiment, the channel change confirmation message 30 which urges the viewer to confirm channel change is displayed immediately before a viewing reservation starting time. If the viewer selects and change a channel according to the viewer's judgment, the channel is switched from a program that the viewer is currently viewing to a program reserved for viewing. On the other hand, if the viewer selects not to change the channel, the program that the viewer is currently viewing is displayed continuously. Consequently, the viewer never misses the program that the viewer is currently viewing or the program reserved for viewing at the starting time of the viewing reservation program. After the viewer changes the channel in accordance with an instruction of the channel change confirmation message 30, the recording confirmation messages 31 and 32 “Do you want to record the channel of the program before the channel change?” and “Do you want to record the reserved channel?” are displayed in association with the programs, respectively. If the viewer selects the recording of the program before the channel change or the reserved channel according to viewer's judgment, it is hardly likely that the start of the recording may delay or the program may be unrecorded. Thus, it is possible to record the program desired by the viewer without failure. In addition, if the viewer selects not to record the program before the channel change or the reserved channel, it is possible to cancel the reservation and prevent useless recording due to a mistake in reservation setting or the like. Further, since the viewer can select whether the channel change confirmation message 30 or/and the recording confirmation messages 31 and 32 should be displayed, it is possible to set a recording operation method convenient for the viewer. Moreover, since the viewer can select the time setting for display timing of the respective messages 30, 31, and 32, it is possible to display the respective messages 30, 31, and 32 at the timing most suitable for the viewer.

As described above, the embodiment of the invention has been described in detail, however, please note the invention is not limited to the embodiment and various modifications of the invention are possible within the scopes of the invention. For example, a circuit structure or the like of the program receiving device only has to be selected according to the circumstances.

1. A broadcast receiver having a viewing reservation function comprising
a viewing reservation data storing unit that stores a channel of a program to be reserved for viewing and a broadcast time frame of the program as viewing reservation data, a message display unit that displays a channel change confirmation message indicating whether a channel should be changed from a program that a viewer is currently viewing to the program reserved for viewing and a recording confirmation message indicating whether the program that the viewer is currently viewing or the program reserved for viewing should be recorded immediately before the start of the program reserved for viewing on the basis of the viewing reservation data from the viewing reservation data storing unit, a channel tuning unit that performs tuning in accordance with an instruction of the channel change confirmation message, and a recording operation unit that obtains time information from the viewing reservation data stored in the viewing reservation data storing unit and records a program according to an instruction of the recording confirmation message at the start of a reservation time.

2. The broadcast receiver having a viewing reservation function according to claim 1, further comprising a selecting means that selects whether the channel change confirmation message or/and the recording confirmation message should be displayed.

3. The broadcast receiver having a viewing reservation function according to claim 1, further comprising a selecting means that selects a time setting for display timing of the channel change confirmation message or/and the recording confirmation message that are displayed before the viewing reservation time.

4. The broadcast receiver having a viewing reservation function according to claim 2, further comprising a selecting means that selects a time setting for display timing of the channel change confirmation message or/and the recording confirmation message that are displayed before the viewing reservation time.
